(19) United States
(12) Patent Application Publication
(10) Pub. No.: US 2019/0087206 A1
(43) Pub. Date: Mar. 21, 2019

(54) CONTEXTUAL SECURITY TRAINING

(71) Applicant: Webroot Inc., Broomfield, CO (US)

(72) Inventors: Paul Barnes, Derby (GB); Niyazi Goknel, Broxbourne (GB)

(73) Assignee: Webroot Inc., Broomfield, CO (US)

(21) Appl. No.: 15/708,851

(22) Filed: Sep. 19, 2017

(51) Int. Cl. G06F 9/44; G06F 21/55; H04L 29/06

(52) U.S. Cl. CPC G06F 9/4446; G06F 21/554; H04L 63/1433; G06F 2221/032; H04L 63/1425; G06F 2221/031; H04L 63/1408

(57) ABSTRACT

Examples of the present disclosure describe systems and methods for contextual security training. In an example, a user may use a user device to perform a variety of actions within a computing environment. Occasionally, the user may encounter a computer issue, which may be identified by an issue detection processor. In some examples, it may be determined that the user should receive contextual training based on the identified issue so as to improve the likelihood that the user will avoid encountering or experiencing a similar issue in the future. Contextual training may be provided based on whether the user has a high incidence of encountering similar issues, among other criteria. If the criteria are satisfied, contextual training may be mandatory. In an example, contextual training may be adapted based on issue attributes to provide training tailored to a specific issue and/or issue type.

### BACKGROUND

Within a computing environment, a user may occasionally encounter a computer issue, such as a computer security threat. In such an example, computer security software may be used to provide protection from the computer security threat. However, while computing security software may provide real-time and/or remedial protection, such software may not offer preventative functionality so as to minimize the potential for future computer issues.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for contextual security training. In an example, a user may use a user device to perform a variety of actions within a computing environment. Occasionally, the user may encounter a computer issue. An issue detection processor may identify the issue, which may cause remedial and/or preventative action to be taken. In some examples, it may be determined that the user should receive contextual training based on the identified issue to improve the likelihood that the user will avoid encountering a similar issue in the future.

In another example, contextual training may be provided to a user based on whether the user has a high incidence of encountering similar issues, among other criteria. If it is determined that the criteria are satisfied, the contextual training may be mandatory. In some examples, contextual training may be adapted based on issue attributes so as to provide training tailored to the specific issue and/or issue type. As such, contextual training may be provided to a user contemporaneously with identifying an issue (e.g., intercepting a threat, encountering a misconfigured computing device, etc.) in order to provide relevant training while the user may be aware of the circumstances surrounding the issue.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for providing contextual security training.

FIG. 2 illustrates an overview of an example method for providing contextual security training.

FIG. 3 illustrates an overview of an example method for generating contextual security training based on a type of issue.

FIG. 4 illustrates an overview of an example method for receiving and displaying contextual security training.

FIG. 5 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

In an example, a user may use a user device to perform a variety computing actions within a computing environment. For example, the user device may be used to access webpages, use an email messaging service, browse local or remote files, or execute applications, among other actions. However, in some examples, the user may encounter or experience an issue. For example, the user may encounter a computer security threat, wherein the user may direct the user device to perform an action that may jeopardize the security of the user device and/or at least a part of the computing environment. In another example, the user may encounter a computing device that is misconfigured or an application of the user's device may be outdated so as to cause incompatibilities within the computing environment. Traditionally, computing software and/or hardware may be used to identify and/or remedy computer issues as they happen or after they happen. However, unless relevant training is provided, subsequent computer issues may continue to be encountered. For example, the user may continue to engage in potentially risky behavior and, as a result, may continue to encounter computing security threats.

Accordingly, the present disclosure provides systems and methods for contextual security training. An issue detection processor may be used to identify an issue. In an example, the issue may be associated with a user action (e.g., opening an email, navigating to a phishing link, misconfiguring an application, incorrectly accessing a shared network resource, etc.) at a user device. The identified issue may be used to determine relevant contextual training for the user, which may comprise a variety of information, including, but not limited to, the type of issue, common issue causes or sources (e.g., threat vectors, application version mismatches, etc.), and techniques for identifying and/or resolving the issue. The contextual training may be presented to the user, which may improve the likelihood that the user will not encounter a similar issue in the future. In some examples, contextual training may only occasionally be presented to the user based on a variety of factors, including, but not limited to, the frequency with which the user encounters a given type of issue or the severity of the issue. Statistics relating to user behavior and issue frequency may be generated and used to provide a report, which may be used to gauge the effectiveness of the training and/or provide subsequent contextual training.

A variety of issue detection processors may be used to identify issues within a computing environment. As an example, an issue detection processor may comprise computer security software executing on a computing device, deep packet inspection performed by a networking device, a plugin or other software package that integrates with another software package (e.g., a browser plugin, an email client extension, etc.), or any combination thereof. In some examples, an issue detection processor may be implemented as hardware, as software, as a single computing device, across multiple computing devices, or any combination thereof. An issue detection processor may analyze network traffic, disk activity, file or memory content, executing processes, software and/or hardware configuration, user account credentials, and/or user activity, among other examples. In another example, other computing device and/or computing environment information may be analyzed, such as application or operating system version information, network configuration information, web browsing or file access history, etc.

In an example, an issue detection processor may identify an issue within a computing environment. In some examples, an issue may comprise a computing security threat, which may be categorized as “malicious,” thereby indicating that the issue is known to be potentially detrimental to computing security. In other examples, an issue may be categorized as “suspicious” or “unknown,” which may indicate that the issue has the potential to be malicious, but with less certainty as compared to issues that are categorized as malicious. Example issues include bot nets, spam messages, keyloggers and other monitoring techniques, malware websites, phishing messages, proxy avoidance or communication anonymizers, spyware, adware, viruses, trojans, rootkits, backdoors, exploits, vulnerabilities, misconfigured or malfunctioning applications or computing devices, or out-of-date software, among other issues. While example categories and issues are described, it will be appreciated that aspects disclosed herein may be applied to any category and/or type of issue.

When an issue is identified, contextual training may be determined for display to a user. In some examples, contextual training may be displayed whenever an issue is identified, or may be displayed based on one or more criteria. Example criteria include past user behavior (e.g., how often a user encounters issues of a similar type, how recent a user last received training, etc.), relative statistics (e.g., how the user compares to similar users with the user's division, how the company compares to similar companies, etc.), and attributes relating to the issue (e.g., issue severity, how recently the issue was discovered, etc.). In some examples, the training may be mandatory, while in other examples the training may be optional or suggested.

Contextual training may be determined from a training data store, which may comprise training information. In an example, the training information may be associated with one or more issues or issue types, such that relevant training information may be identified using the issue and/or issue type. In another example, training information may comprise a variety of stages or levels, wherein a first stage may be presented to a user when the user first encounters an issue, while a subsequent stage may be presented if the user continues to encounter similar issues. In some examples, aspects of the training information may be adapted based on the issue (e.g., based on the issue type or the source of the issue, among other issue attributes). As a result, the user may receive relevant training that is tailored to the identified issue. Further, the training may be provided contemporaneously, thereby enabling the user to better understand the training while the issue is still recent in the memory of the user.

In some examples, a report may be generated to provide information relating to the effectiveness of contextual training, the state of users and/or devices in the network, and/or historical metrics, among other information. A report may be generated based on user behavior information, which may comprise information relating to user behavior before and/or after receiving contextual training. In an example, the user behavior information may be collected on an opt-in basis, wherein a user may indicate that user behavior information may be collected in order to perform analysis. In some examples, a report may provide information for a subset of users (e.g., a user group, a division, a team, etc.), a company, or a geographic region. In other examples, a report may provide a comparison for a set of users as compared to information from a comparable set of users (e.g., at a division-level, company-level, or geographic-level, etc.).

As used herein, a user may occupy any of a variety of roles. For example, a user may be an employee of a company, a personal user, or an administrative user. In some examples, contextual training may be determined based on a user's role, experience, or other user attributes. As an example, an administrative user may receive more technical or in-depth contextual training. In another example, a personal user may not receive training relating to network or firewall issues, as such training may be more relevant for an administrative user. In some examples, an issue may comprise the behavior of one or more other users. For example, for an administrative user, contextual training may be received based on the behavior of users within the computing environment.

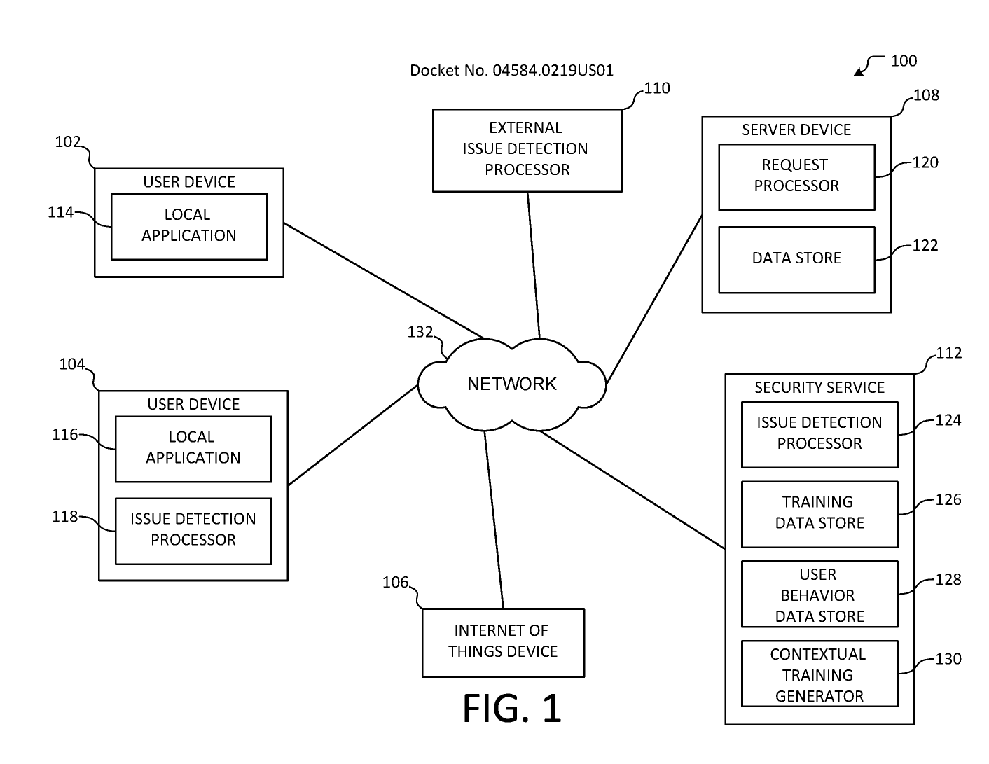

FIG. 1 illustrates an overview of an example system 100 for contextual security training. As illustrated, system 100 is comprised of user devices 102 and 104, internet of things (IoT) device 106, server device 108, external issue detection processor 110, and security service 112, all of which may be connected via network 132. In an example, network 132 may facilitate wired and/or wireless communication between entities 102-112. In some examples, network 132 may comprise a local area network, a wide area network, a virtual private network, and/or the Internet. In other examples, network 132 may be comprised of one or more networking devices, including, but not limited to, a router, a managed or unmanaged switch, a gateway, a modem, an access point, or a firewall.

User devices 102 and 104 may be computing devices, including, but not limited to, mobile computing devices, tablet computing devices, desktop computing devices, and/or laptop computing devices. In examples, user devices 102 and 104 may comprise local applications 114 and 116, respectively. In an example, each of local applications 114 and 116 may be an email application, a web browser application, a document editor, an image or portable document format (PDF) file viewer, a cloud-based or web-based application, or a locally-executed application, among other applications. It will be appreciated that local applications 114 and 116 may be similar or different applications from one another, and may be any of a variety of applications. In some examples, local application 114 or 116 may be a client used to interact with a remote service, such as a service which may be provided by server device 108. For example, user device 102 may access a website provided by server device 108. In some examples, request processor 120 may comprise a webserver, which may process requests from user device 102 and generate responses accordingly. In another example, user device 104 may access files stored by data store 122 of server device 108. In some examples, IoT device 106 may be any of a wide array of “smart” devices, including, but not limited to, connected appliances, entertainment devices, or wearable devices. In some examples, local applications 114 and/or 116 may be used to interact with IoT device 106. While example actions are discussed with reference to system 100, it will be appreciated that any of a variety of other actions may be performed as well.

As illustrated, user device 104 further comprises issue detection processor 118. In some examples, issue detection processor 118 may be used to identify issues relating to user device 104. In other examples, external issue detection processor 110 and/or issue detection processor 124 of security service 112 may be used in conjunction with issue detection processor 118 in order to detect issues within system 100. In an example, issue detection processor 118 may be a locally executing application or may be a plugin or other software package that integrates with another software package (e.g., local application 116). In another example, user device 102 may not comprise local issue detection (e.g., similar to that of issue detection processor 118) and may instead use aspects of external issue detection processor 110 and/or issue detection processor 124 to identify issues.

External issue detection processor 110 may comprise computer security software. In another example, external issue detection processor may engage in deep packet inspection of network 132, or may receive deep packet inspection information from one or more network devices of network 132. In some examples, external issue detection processor 110 may be implemented as hardware, as software, as a single computing device, across multiple computing devices, or any combination thereof. In another example, external issue detection processor 110 may be provided by a third party, or may be provided as a standalone security offering. It will be appreciated that issue detection processor 124 of security service 112 and issue detection processor 118 of user device 104 may provide similar or different functionality, as was described herein with respect to external issue detection processor 118.

Security service 112 may be a service for providing computing security within a computing environment. It will be appreciated that while security service 112 is illustrated as comprising elements 124-130, fewer, additional, or alternative elements may be used, or security service 112 may be provided as part of a distributed computing device or a cloud-computing system. As illustrated, security service 112 further comprises training data store 126, user behavior data store 128, and contextual training generator 130. In an example, training data store 126 may comprise training information according to aspects disclosed herein. In another example, the training information may be associated with one or more issues or issue types, such that relevant training information may be identified using the issue and/or issue type. While training data store 126 is illustrated as part of security service 112, it will be appreciated that training information may be accessed from any of a variety of other sources, including, but not limited to, a third party security service or a training data store that is remote from security service 112.

User behavior data store 128 may comprise information relating to the behavior of one or more users (e.g., users of user devices 102 and/or 104, as well as IoT device 106). In an example, user behavior information may be collected on an opt-in basis. In some examples, user behavior data store 128 may comprise information relating to a user's behavior before and/or after receiving contextual training. For example, user behavior data store 128 may comprise information relating to user actions, logs or diagnostic information from one or more user devices used by the user, or previously received training, among other information. According to aspects described herein, information stored by user behavior data store 128 may be used to generate analytics and/or reports relating to the effectiveness of contextual training, as well as the current and/or historical state of at least a subpart of system 100.

Contextual training generator 130 may be used to determine contextual training for an identified issue (e.g., as may be identified by external issue detection processor 110, issue detection processor 118, and/or issue detection processor 124). In some examples, determining contextual training may comprise evaluating training information stored by training data store 126. In an example, the training information may be identified based on an association with a given issue and/or issue type. In other examples, contextual training generator 130 may adapt training information based on attributes of the identified issue, including, but not limited to, the source of the issue or the type of issue. While example generation techniques are described herein, it will be appreciated that any of a variety of techniques may be used.

In an example, a user may use local application 114 of user device 102 to access an email inbox stored by server device 108. The user may open an email message from the email inbox, wherein the email message may comprise a phishing link. When the user clicks on the link to load the website associated with the link, external issue detection processor 110 and/or issue detection processor 124 may identify the phishing threat and may intercept the request for the website. As a result, a different website indicating the issue was blocked may be loaded. In an example where external issue detection processor 110 intercepts the request, an indication may be provided to security service 112, which may be used to determine whether contextual training should be provided. Similarly, if issue detection processor 124 intercepts the request, contextual training generator 130 may be used to determine whether contextual training should be provided.

The determination may comprise an analysis of user behavior information stored by user behavior data store 128 according to aspects disclosed herein. For example, if it is determined that the user frequently clicks on phishing links, contextual training may be generated by contextual training generator 130 (e.g., based on training information stored by training data store 126). The contextual training may be provided as part of the different website provided to user device 102. For example, the contextual training may comprise at least a part of a webpage or video content relating to the issue type. As a result, the phishing website may not be accessed by the user, and the user may instead contemporaneously receive contextual training relating to the identified issue.

In another example, network activity of IoT device 106 over network 136 may be monitored by external issue detection processor 110 and/or issue detection processor 124. If malicious or suspicious network activity is identified as an issue, contextual training may be generated according to aspects disclosed herein. For example, it may be determined that a user uses local application 116 of user device 104 to interact with IoT device 106, such that contextual training regarding the identified issue may be provided to the user of user device 104. In some examples, it may be determined that the user rarely experiences issues similar to the identified issue and/or the issue is unlikely to occur again. As a result, in such examples, the issue may be remedied without providing contextual training to the user. While examples are discussed above with respect to system 100, it will be appreciated that a wide variety of issues may be identified and used to generate contextual training according to aspects disclosed herein.

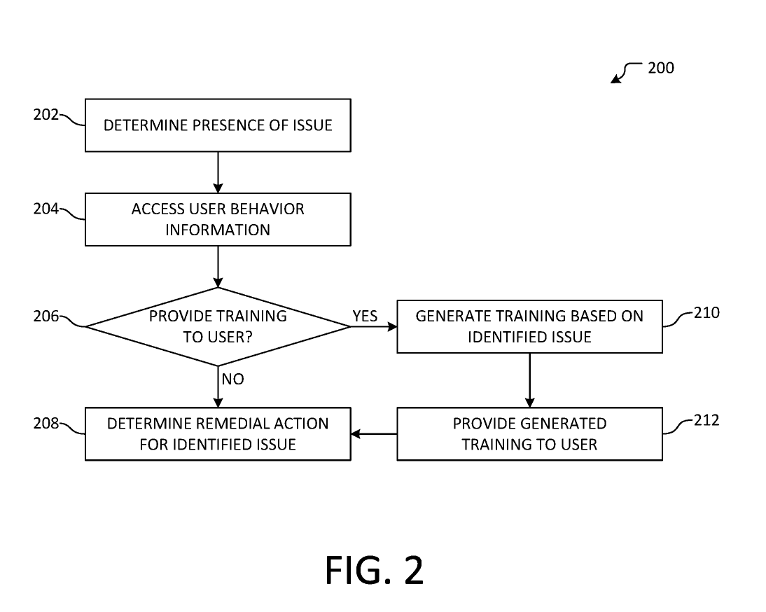

FIG. 2 illustrates an overview of an example method 200 for providing contextual security training. In an example, method 200 may be performed by a computing device. In another example, method 200 may be performed by security service 112 in FIG. 1. Method 200 begins at operation 202, where the presence of an issue may be determined. In an example the issue may be determined by an issue detection processor, such as issue detection processors 110, 118, and/or 124 in FIG. 1. In some examples, the issue may be determined based on an indication received from an issue detection processor (e.g., via an application programming interface (API), webhook, callback, etc.). In other examples, the issue may be determined directly based on identifying the issue within a computing environment. In an example, the issue may be associated with an action of a user, such as executing a malicious executable, opening a phishing link, attempting to use an anonymizer, or installing outdated or incompatible software, among other actions.

Moving to operation 204, user behavior information may be accessed. In an example, user behavior information may be accessed from a user behavior data store, such as user behavior data store 128 in FIG. 1. In some examples, the user behavior information may comprise information relating to one or more past actions of the user, logs or diagnostic information from one or more user devices used by the user, or previously received training, among other information. The user behavior information may be associated with the user as part of a user behavior data store so as to facilitate retrieval of the user behavior information.

At determination 206, it may be determined whether to provide training to the user. The determination may comprise evaluating the accessed user behavior information based on one or more criteria. Example criteria include past user behavior (e.g., how often a user encounters issues of a similar type, how recent a user last received training, etc.), relative statistics (e.g., how the user compares to similar users with the user's division, how the company compares to similar companies, etc.), and attributes relating to the issue (e.g., issue severity, how recently the issue was discovered, etc.). In some examples, the training may be mandatory, while in other examples the training may be optional or suggested.

If it is determined that training should not be provided to the user, flow branches “NO” to operation 208, where remedial action may be determined for the identified issue. In some examples, the remedial action may be determined by an issue detection processor, or may be determined by another processor. In other examples, a remedial action may be determined based on information relating to the issue and/or to the user. In another example, no remedial action may be determined. Flow terminates at operation 208.

If, however, it is determined that training should be provided to the user, flow branches “YES” to operation 210, where contextual training may be generated based on the identified issue. In an example, contextual training may be generated by contextual training generator 130 in FIG. 1. In another example, generating contextual training may comprise evaluating training information stored by a training data store, such as training data store 126 in FIG. 1. For example, training information may be identified based on an association with the determined issue and/or issue type. In other examples, contextual training may be generated by adapting training information based on attributes of the determined issue, including, but not limited to, the source of the issue or the type of issue. While example generation techniques are described herein, it will be appreciated that any of a variety of techniques may be used.

Flow progresses to operation 212, where the generated contextual training may be provided to the user. In an example, providing the contextual training may comprise inserting the contextual training as part of a response to the determined issue. For example, the contextual training may be part of a website to which a user's device may be redirected when an issue is blocked. In another example, the contextual training may be provided to the user as a video for playback by a user device. It will be appreciated that contextual training may comprise any of a variety of content, including, but not limited to, text, images, video, and/or presentation slides, etc. Flow then moves to operation 208, where a remedial action may be determined for the issue, as was discussed above. Flow terminates at operation 208.

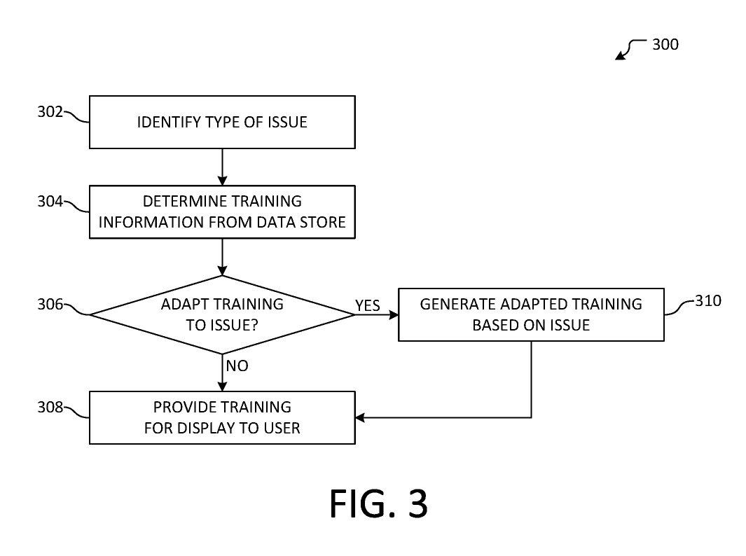

FIG. 3 illustrates an overview of an example method 300 for generating contextual security training based on a type of issue. In an example, method 300 may be performed by a computing device. In another example, method 300 may be performed by security service 112 in FIG. 1. In some examples, aspects of method 300 may be performed at operation 210 of method 200, as discussed above with respect to FIG. 2. Method 300 begins at operation 302, where a type of issue may be determined. Example issues include bot nets, spam messages, keyloggers and other monitoring techniques, malware websites, phishing messages, proxy avoidance or communication anonymizers, spyware, adware, viruses, trojans, rootkits, backdoors, exploits, vulnerabilities, misconfigured or malfunctioning applications or computing devices, or out-of-date software, among other issues. In some examples, the type of issue may be determined by an issue detection processor (e.g., the issue detection processor may be specialized for identifying the specific type of issue or may use heuristics to determine the type of issue, etc.).

At operation 304, training information may be determined from a data store. In an example, training information may be accessed from a training data store, such as training data store 126 in FIG. 1. The training information may be determined based on an association of the training information with a specific and/or general issue type, or with an issue itself (e.g., where a known issue is identified as recurring or affecting another computing device, etc.). In an example, training information may be cached or stored at a local data store, or may be accessed from a remote source, among other sources.

Flow progresses to determination 306, where it may be determined whether to adapt the identified training information to the identified issue. The determination may comprise evaluating the determined training information (e.g., whether the training information comprises one or more placeholders that may be updated to contain issue-specific information) or information associated with the user (e.g., how often the user encounters the type of issue, the role of the user, etc.), among other information. For example, if the user often encounters the type of issue, it may be determined that the training information should be adapted to comprise additional training beyond the contextual training ordinarily provided to users that less frequently encounter the issue type. As another example, if the user is an administrative user, it may be determined that additional or different training may be provided so as to educate the administrative user on techniques that may be used to avoid or mitigate the issue in the future.

If it is determined that the training information should not be adapted, flow branches “NO” to operation 308, where the contextual training may be provided for display to the user. As an example, the contextual training may be provided as part of a website to which the user's device was redirected when the issue was blocked. In another example, the contextual training may be provided to the user as a video for playback by a user device. It will be appreciated that contextual training may comprise any of a variety of content, including, but not limited to, text, images, video, and/or presentation slides, etc. Flow terminates at operation 308.

If, however, it is determined that the training information should be adapted, flow branches “YES” to operation 310, where the training information may be adapted according to aspects disclosed herein. As an example, the training information may be adapted to incorporate issue-specific information, such as an issue source, a port number associated with the issue, or information relating to affected files, among other information. In another example, the training information may be adapted to select from one or more stages, wherein a first stage may be presented to a user when the user first encounters an issue, while a subsequent stage may be presented if the user continues to encounter similar issues. While example adaptation and generation techniques are discussed herein, it will be appreciated that any of a variety of other techniques may be used. Flow then progresses to operation 308, where the contextual training may be provided for display to the user, as was discussed above. Flow terminates at operation 308.

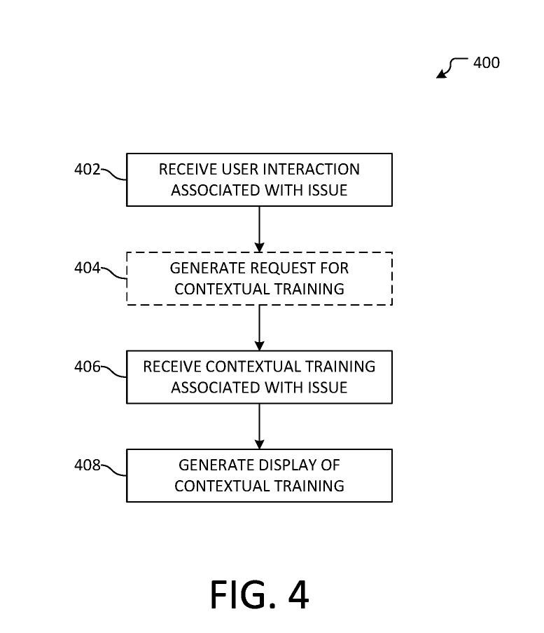

FIG. 4 illustrates an overview of an example method 400 for receiving and displaying contextual security training. In an example, method 400 may be performed by a computing device, such as user device 102 or 104 in FIG. 1. Method 400 begins at operation 402, where a user interaction associated with an issue may be received. In some examples, the user interaction may be determined to be an issue by an issue detection processor after the user interaction is received. As an example, the received interaction may comprise opening a link using a web browser, which may cause an issue detection processor to determine that the link is associated with a fraudulent website. It will be appreciated that any of a variety of user interactions may be received without departing from the spirit of this disclosure.

Flow progresses to operation 404, where a request may be generated for contextual training. The request may comprise information relating to the issue, such as an issue type or issue source. In some examples, the request may comprise user behavior information, which may be stored locally or accessed from a remote data store (e.g., user behavior data store 128 in FIG. 1), or a combination thereof. In an example, the request may be for contextual training which may be stored locally. In another example, the request may be provided to a contextual training generator, such as contextual training generator 130 in FIG. 1. Operation 404 is illustrated using a dashed box, thereby indicating that operation 404 may be optional. In some examples, flow may progress directly from operation 402 to operation 406, such that contextual training may be received without generating an explicit request.

At operation 406, contextual training associated with the issue may be received. In some examples, the contextual training may have been generated according to aspects of methods 200 and/or 300 described above with respect to FIGS. 2 and 3, respectively. In an example, the contextual training may be received as part of a website relating to the issue (e.g., the website may indicate the issue was blocked and comprise the contextual training, or may provide a link with which to access the contextual training, etc.). In another example, the contextual training may be received by a local issue detection processor or may be accessed from a local data store.

Moving to operation 408, a display may be generated for the contextual training. In some examples, the display may comprise rendering a webpage comprising the contextual training. In other examples, the display may comprise an alert (e.g., as may be generated by a local issue detection processor or other application) comprising the contextual training. It will be appreciated that while example display techniques are described herein, any of a variety of other techniques may be used to display the contextual training. Flow terminates at operation 408.

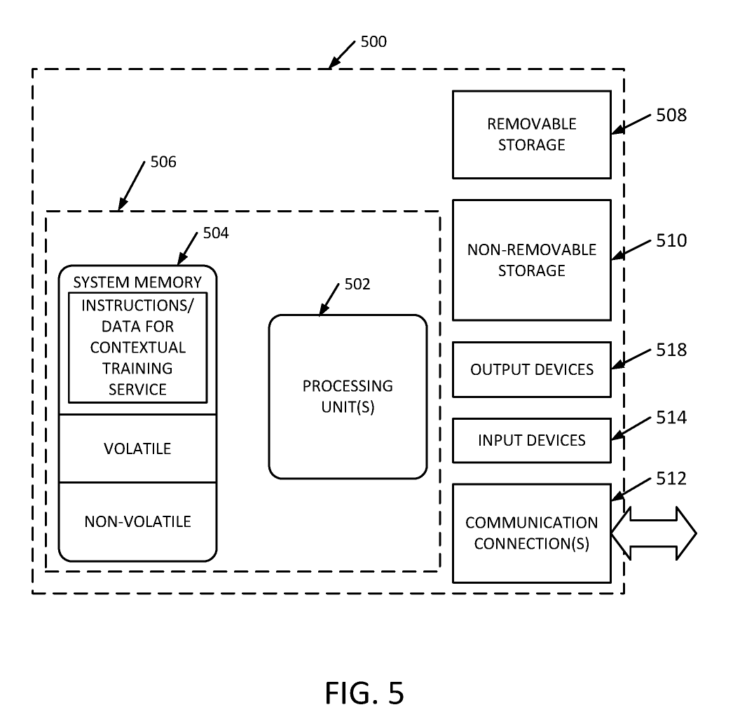

FIG. 5 illustrates one example of a suitable operating environment 500 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 500 typically includes at least one processing unit 502 and memory 504. Depending on the exact configuration and type of computing device, memory 504 (storing, among other things, contextual training information, user behavior information, issue detection information, instructions to perform the methods disclosed herein, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as keyboard, mouse, pen, voice input, etc. and/or output device(s) 516 such as a display, speakers, printer, etc. Also included in the environment may be one or more communication connections, 512, such as LAN, WAN, point to point, etc.

Operating environment 500 typically includes at least some form of computer readable media. Computer readable media can be any available media that can be accessed by processing unit 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

As will be understood from the foregoing disclosure, one aspect of the technology relates to a system comprising: at least one processor; and memory storing instructions that, when executed by the at least one processor, causes the system to perform a set of operations. The set of operations comprises: receiving an indication of an issue associated with an action of a user; determining, based on behavior information for the user, whether the user should receive contextual training; based on determining the user should receive contextual training, accessing a training data store to identify training information associated with the issue; generating, based on the training information, contextual training for the issue based on the action of the user; and providing the generated contextual training for display to the user. In an example, the set of operations further comprises intercepting a request associated with the action of the user. In another example, providing the generated contextual training comprises providing the generated contextual training in response to the intercepted request. In a further example, determining whether the user should receive contextual training comprises an analysis of historical issue interactions for the user. In yet another example, generating contextual training comprises adapting the training information based on one or more attributes of the issue. In a further still example, the set of operations further comprises updating the behavior information for the user based on one or more user actions after providing the generated contextual training for display to the user. In another example, the indication of the issue is received from an issue detection processor.

In another aspect, the technology relates to a method for generating contextual training based on an issue. The method comprises: receiving, from an issue detection processor, an indication of the issue associated with an action of a user; determining whether the user should receive contextual training; based on determining the user should receive contextual training, identifying training information associated with the issue from a training data store; adapting the identified training information based on one or more attributes of the issue to generate contextual training; and providing the generated contextual training for display to the user. In an example, the method further comprises intercepting a request from a device of the user, wherein the request is associated with the action of the user. In another example, providing the generated contextual training comprises providing the generated contextual training in response to the intercepted request. In a further example, determining whether the user should receive contextual training comprises an analysis of historical issue interactions for the user. In yet another example, the method further comprises updating behavior information for the user based on one or more user actions after providing the generated contextual training for display to the user. In a further still example, providing the generated contextual training for display to the user comprises providing the contextual training to a device of the user for display contemporaneously with an occurrence of the issue associated with the action of the user.

In a further aspect, the technology relates to a method for generating contextual training based on an issue. The method comprises: receiving an indication of the issue associated with an action of a user; determining, based on behavior information for the user, whether the user should receive contextual training; based on determining the user should receive contextual training, accessing a training data store to identify training information associated with the issue; generating, based on the training information, contextual training for the issue based on the action of the user; and providing the generated contextual training for display to the user. In an example, the method further comprises intercepting a request associated with the action of the user. In another example, providing the generated contextual training comprises providing the generated contextual training in response to the intercepted request. In a further example, determining whether the user should receive contextual training comprises an analysis of historical issue interactions for the user. In yet another example, generating contextual training comprises adapting the training information based on one or more attributes of the issue. In a further still example, the method further comprises updating the behavior information for the user based on one or more user actions after providing the generated contextual training for display to the user. In another example, the indication of the issue is received from an issue detection processor.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving an indication of an issue associated with an action of a user;
determining, based on behavior information for the user, whether the user should receive contextual training;
based on determining the user should receive contextual training, accessing a training data store to identify training information associated with the issue;
generating, based on the training information, contextual training for the issue based on the action of the user; and
providing the generated contextual training for display to the user.

2. The system of claim 1, wherein the set of operations further comprises intercepting a request associated with the action of the user.

3. The system of claim 2, wherein providing the generated contextual training comprises providing the generated contextual training in response to the intercepted request.

4. The system of claim 1, wherein determining whether the user should receive contextual training comprises an analysis of historical issue interactions for the user.

5. The system of claim 1, wherein generating contextual training comprises adapting the training information based on one or more attributes of the issue.

6. The system of claim 1, wherein the set of operations further comprises updating the behavior information for the user based on one or more user actions after providing the generated contextual training for display to the user.

7. The system of claim 1, wherein the indication of the issue is received from an issue detection processor.

8. A method for generating contextual training based on an issue, comprising:
receiving, from an issue detection processor, an indication of the issue associated with an action of a user;
determining whether the user should receive contextual training;
based on determining the user should receive contextual training, identifying training information associated with the issue from a training data store;
adapting the identified training information based on one or more attributes of the issue to generate contextual training; and
providing the generated contextual training for display to the user.

9. The method of claim 8, further comprising:
intercepting a request from a device of the user, wherein the request is associated with the action of the user.

10. The method of claim 9, wherein providing the generated contextual training comprises providing the generated contextual training in response to the intercepted request.

11. The method of claim 8, wherein determining whether the user should receive contextual training comprises an analysis of historical issue interactions for the user.

12. The method of claim 8, further comprising:
updating behavior information for the user based on one or more user actions after providing the generated contextual training for display to the user.

13. The method of claim 8, wherein providing the generated contextual training for display to the user comprises providing the contextual training to a device of the user for display contemporaneously with an occurrence of the issue associated with the action of the user.

14. A method for generating contextual training based on an issue, comprising:
receiving an indication of the issue associated with an action of a user;
determining, based on behavior information for the user, whether the user should receive contextual training;
based on determining the user should receive contextual training, accessing a training data store to identify training information associated with the issue;
generating, based on the training information, contextual training for the issue based on the action of the user; and
providing the generated contextual training for display to the user.

15. The method of claim 14, further comprising:
intercepting a request associated with the action of the user.

16. The method of claim 15, wherein providing the generated contextual training comprises providing the generated contextual training in response to the intercepted request.

17. The method of claim 14, wherein determining whether the user should receive contextual training comprises an analysis of historical issue interactions for the user.

18. The method of claim 14, wherein generating contextual training comprises adapting the training information based on one or more attributes of the issue.

19. The method of claim 14, further comprising:
updating the behavior information for the user based on one or more user actions after providing the generated contextual training for display to the user.

20. The method of claim 14, wherein the indication of the issue is received from an issue detection processor.
